(19) United States
(12) Patent Application Publication
(10) Pub. No.: US 2006/0284922 A1
(43) Pub. Date: Dec. 21, 2006

(54) Array type inkjet printer and maintenance method thereof

(75) Inventor: O-hyun Beak, Seoul (KR)

Correspondence Address: STANZIONE & KIM, LLP, 919 18TH STREET, N.W., SUITE 440, WASHINGTON, DC, 20006, US

(73) Assignee: Samsung electronics Co., Ltd., Suwon-si (KR)

(21) Appl. No.: 11/450,372

(22) Filed: Jun. 12, 2006

(30) Foreign Application Priority Data
Jun. 20, 2005 (KR) 2005-52938
Apr. 3, 2006 (KR) 2006-30131

(51) Int. Cl. B41J 2/165

(52) U.S. Cl. 347/23; 347/29

(57) ABSTRACT

An array type inkjet printer having an elongated print head and a plurality of nozzles disposed along a lengthwise direction, and a maintenance method thereof. The array type inkjet printer includes a discharge number calculating unit to calculate a number of times that each nozzle discharges ink based on an image to be printed, a cap-open time calculating unit to calculate cap-open time to open a discharge port of each nozzle, and a control unit to control a maintenance operation to be performed on a nozzle when the cap open time reaches a predetermined reference time and when the number of discharging times of the nozzle is below a predetermined reference value. Accordingly, it is possible to prevent unnecessary ink consumption during maintenance operations, and extend a lifespan of the print head and the nozzles.

### CROSS-REFERENCE TO RELATED APPLICATIONS

This application claims the benefit under 35 U.S.C. § 119(a) of Korean Patent Applications Nos. 2005-52938 and 2006-30131, filed Jun. 20, 2005 and Apr. 3, 2006, respectively, in the Korean Intellectual Property Office, the entire contents of which are incorporated herein by reference.

### BACKGROUND OF THE INVENTION

1. Field of the Invention

The present general inventive concept relates to an array type inkjet printer and a maintenance method thereof. More particularly, the present general inventive concept relates to an array type inkjet printer and a maintenance method thereof, which reduces ink consumed by maintenance operations performed on nozzles.

2. Description of the Related Art

Generally, an array type inkjet printer has a print head formed to have a length extending in one direction. The print head is provided with many nozzles in the lengthwise direction thereof. Each of the nozzles has a discharge port for spitting ink, and a cap for opening or closing the discharge port.

The array type inkjet printer counts a discharge number (i.e., a number of times ink is ejected) for each of the nozzles when power is supplied, or before printing is started. When any one of the nozzles has exceeded a predetermined number of discharges, maintenance is performed. The maintenance includes several jobs such as, spitting and wiping, etc.

The spitting spits the ink from each of the nozzles and to discharge ink that is hardened on the discharge port. The spitting is designed to realize high quality printing by keeping a smooth flow of ink from deteriorating due to the hardening of the ink. Generally, in operation of the array-type of inkjet printer, the caps for opening or closing each nozzle are all opened at the same time. In this situation, some of the nozzles spit the ink for printing image, while others do not spit ink according to types of the images to be printed. Accordingly, the ink is repeatedly exposed to air through the nozzles not in use when printing the images. As a result, the ink on the nozzles that are not in use hardens. Once the ink hardens on these nozzles, these nozzles do not properly discharge ink for printing when these nozzles are required to print. In an effort to prevent these nozzles from malfunctioning, all the nozzles are controlled to perform the spitting.

The wiping wipes the discharge ports of each of the nozzles using a wiper. Repeated printing may produce a collection of ink around the discharge port and as more ink is wasted thereon, ink may spread on paper and/or the discharge port may get clogged. The wiping can prevent this inconvenience.

In many cases, a printing image does not occupy an entire surface of the paper. For example, in order to print an image as illustrated in FIG. 1, nozzles on a central part of a print head 1 are frequently used, while nozzles on both ends (encircled area) of the print head 1 are rarely used. The rarely used nozzles need spitting, while the frequently used nozzles do not need spitting. However, in a conventional array type inkjet printer and print head, all the nozzles are required to perform spitting at the same time, thereby unnecessarily wasting ink.

More particularly, the array type inkjet printer has far more nozzles than a shuttle type of printer. If all the nozzles perform spitting, a substantial amount of ink is consumed.

### SUMMARY OF THE INVENTION

The present general inventive concept provides an array type inkjet printer and a maintenance method thereof, which can reduce ink consumption during maintenance operation(s) performed by/on nozzles.

The present general inventive concept also provides adaptive maintenance, such as spitting and wiping, that is performed according to a number times each nozzle is used in an array type inkjet printer such that ink consumption is reduced and efficient maintenance is performed.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an array type inkjet printer having an elongated print head and a plurality of nozzles disposed along a lengthwise direction of the print head, the array type inkjet printer including a discharge number calculating unit to calculate a number of times that each nozzle discharges ink based on an image to be printed, a cap-open time calculating unit to calculate a cap-open time during which a discharge port of each nozzle is opened by a corresponding cap, and a control unit to control a maintenance operation to be performed on a nozzle when the cap open time reaches a predetermined reference time and when the number of discharging times of the nozzle is below a first predetermined reference value.

The discharge number calculating unit extracts at least one of information about a position of ink dots in the image to be printed and information about a color of each of the ink dots forming the image to be printed.

The discharge number calculating unit extracts the number of ink discharges of each nozzle corresponding to each ink dot from the at least one of the information about the position of the ink dots in the image to be printed and the information about the color of the ink dots forming the image to be printed.

The printer may further include a maintenance-needed nozzle determining unit to determine a nozzle in need of maintenance when the number of ink discharges of the nozzle is less than or equal to the first predetermined reference value for the predetermined reference time.

The maintenance operation may include at least one of a spitting operation to spit ink from the nozzles and a wiping operation to wipe the discharge ports of the nozzles with a wiper.

The control unit may control the print head such that the nozzle in need of maintenance performs the spitting operation when the cap-open time reaches the predetermined reference time.

The nozzles each include a nozzle heater to heat the ink, and the control unit operates the nozzle heaters to perform the spitting operation.

The control unit resets the cap-open time and the information about the nozzle in need of maintenance, after the spitting operation is completed.

The control unit controls the print head and the wiper such that all the nozzles perform the spitting operation and the wiper performs the wiping operation on all the nozzles when the number of ink discharges of at least one nozzle exceeds a second predetermined reference value, and the control resets the cap open time and the information about the nozzle in need of maintenance after the spitting and wiping operations are completed.

The predetermined reference time may be set based on ink hardening time in the nozzles.

The foregoing and/or other aspects of the present general inventive concept are also achieved by providing a printer, including a print head unit having a plurality nozzles, a maintenance unit to monitor a frequency of ink ejection over a predetermined time cycle of each of the nozzles, and a control unit to control the print head unit to print an image and to individually control a nozzle having a low frequency of ink ejection over the predetermined time cycle during the printing of the image to perform a spitting operation.

The foregoing and/or other aspects of the present general inventive concept are also achieved by providing a printer, including a print head unit having a plurality nozzles to print an image during a print job, a maintenance unit to count a number of ink ejections performed by each nozzle during a plurality of predetermined time intervals of the print job, and a control unit to control the nozzles of the print head to perform a predetermined maintenance operation each at different times according to respective counted numbers of ink ejections.

The foregoing and/or other aspects of the present general inventive concept are also achieved by providing a printer, including a print head having a plurality of nozzles to print an image, a maintenance unit to perform maintenance on the print head, and a control unit to control the maintenance unit to perform one or more regularly scheduled maintenance processes on the print head and to control the maintenance unit to perform one or more non-regular adaptive maintenance processes on the print head based on the image printed.

The foregoing and/or other aspects of the present general inventive concept are also achieved by providing a maintenance method of an array type inkjet printer having an elongated print head and a plurality of nozzles disposed along a lengthwise direction of the print head, the method including calculating a number of times that each nozzle discharges ink based on an image to be printed, calculating a cap-open time during which a discharge port of each nozzle is opened by a corresponding cap, and performing a maintenance operation on a nozzle when the cap open time reaches a predetermined reference time and when the number of discharging times of the nozzle is below a first predetermined reference value.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a perspective view illustrating printing operation of a print head of an array-type of inkjet printer;

FIG. 2 is a block diagram illustrating an array type inkjet printer according to an embodiment of the present general inventive concept;

FIG. 3 is a graph illustrating a number of times ink is discharged from nozzles in print head during a preset reference time, according to an embodiment of the present general inventive concept; and

FIG. 4 is a flow chart illustrating a maintenance method using an array type inkjet printer according to an embodiment of the present general inventive concept.

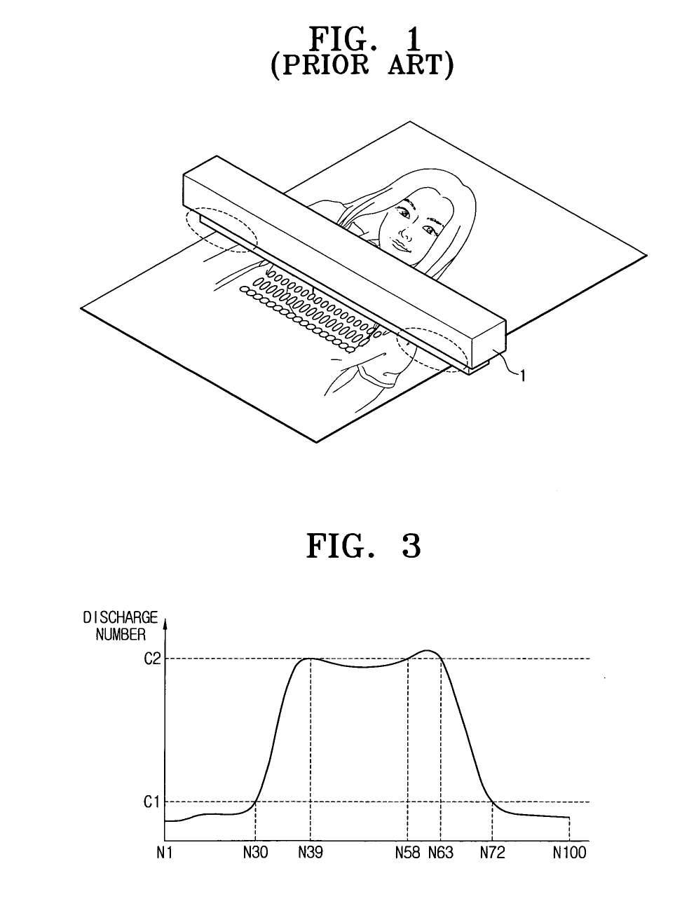

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

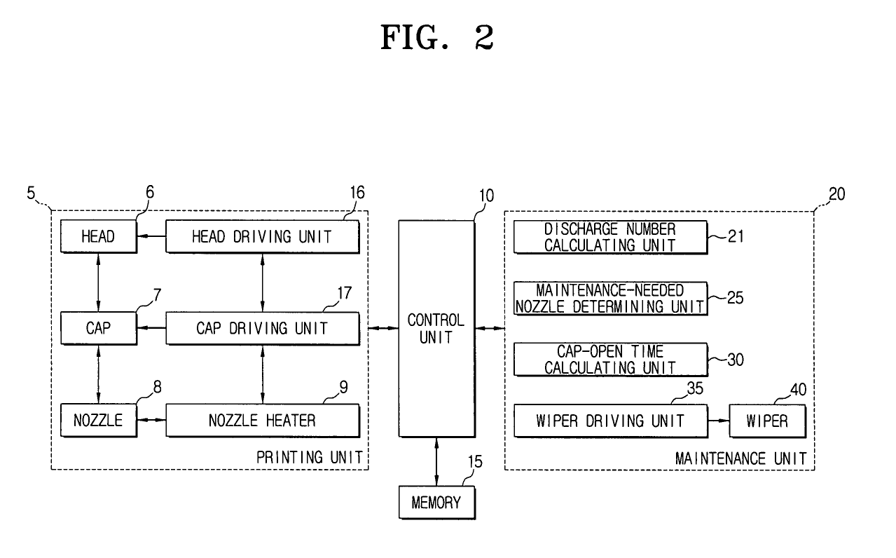

FIG. 2 is a block diagram illustrating an array type inkjet printer according to an embodiment of the present general inventive concept.

As illustrated in FIG. 2, the array type-inkjet printer includes a printing unit 5, a maintenance unit 20, a memory 15, and a control unit 10.

The printing unit 5 prints an image, and the printing unit 5 includes a print head 6, a head driving unit 16, a cap 7, a cap driving unit 17, and a nozzle heater 9. Although the printing unit 5 is illustrated as having one cap 7, one nozzle 8, etc, it should be understood that the nozzle 8 represents a plurality of nozzles 8 and the cap 7 represents a plurality of caps 7, and that the nozzles 8 are formed in the print head 6, in practice.

The print head 6 is formed to have a long bar-like shape extending in one direction, and a paper-facing surface of the print head 6 has many nozzles 8. The nozzles 8 are formed with discharge ports disposed in the paper-facing surface of the print head 6 to discharge ink, and each of the nozzles 8 are disposed with caps 7 to open and close the discharge ports of the nozzles 8.

The head driving unit 16 moves the print head 6 lengthwise (i.e., perpendicular to a print medium transfer direction) while printing data to the print medium to form the image thereon. The print head 6 may have a length that is greater than or equal to a width of the print medium.

The cap driving unit 17 opens or closes the caps 7 under the control of the control unit 10, and opens the caps when maintenance operations are performed on the nozzles 8.

The nozzle heater 9 is disposed inside the print head 6 adjacent to the discharge ports of the nozzles 8 to heat ink such that the ink is spit (i.e., ejected) through the respective discharge ports. Generally, there are several methods of spitting or ejecting ink. A thermal ink spitting method is widely used to spit the ink by generating heat using the nozzle heater 9. The nozzle heater 9 may be a thin film heater to generate the heat when a current is applied. When the heat is generated by the nozzle heater 9, the ink is heated and is converted into a gaseous state. Accordingly, a volume of the ink changes, and the ink is pushed by ink bubbles such that ink drops are spit through the discharge ports.

The maintenance unit 20 includes a discharge number calculating unit 21, a maintenance-needed nozzle determining unit 25, a cap-open time calculating unit 30, a wiper 40, and a wiper driving unit 35.

The discharge number calculating unit 21 calculates a number of ink discharges (i.e., ink ejections) of the nozzles 8 to print the printing data. In order to do so, the discharge number calculating unit 21 extracts information about a number and a position of ink dots for the printing data, and determines whether each of the nozzles 8 discharge ink based on the extracted information. A color printer having different color nozzles C (cyan), M (magenta), and Y (yellow) may consider color information about the printing data and calculates the discharge number.

The discharge number calculating unit 21 calculates the discharge number accumulated when printing of the printing data is performed by each of the nozzles 8. In particular, the discharge number calculating unit 21 may individually determine the discharge number for each nozzle in the print head 6. When the printing data is in color, the discharge number calculating unit 21 may consider how many colors are included in one ink dot and may calculate the number of ink discharges performed by each of the nozzles 8.

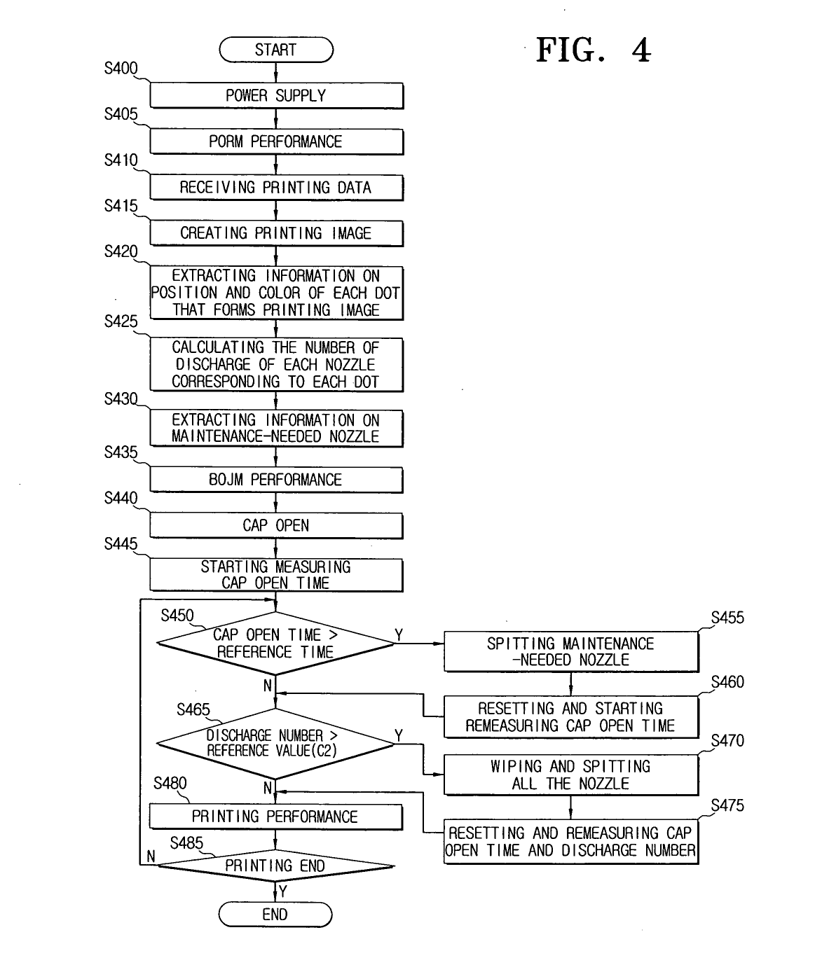

FIG. 3 is a graph illustrating a number of times the ink is discharged from nozzles 8 in print head 6 during a preset reference time, according to an embodiment of the present general inventive concept. For description purposes, it can be assumed that there are 100 nozzles 8 in the print head 6. Obviously, other numbers and arrangements of nozzles 8 may also be used in the print head 6. As illustrated in FIG. 3, it can be seen that the nozzles N1 to N30 and N72 to N100, which are positioned at ends of the print head 6, are used less frequently to print the image during the preset reference time than are other nozzles in the print head 6.

The maintenance-needed nozzle determining unit 25 determines any nozzle 8 in need of maintenance due to the possibility of ink hardening thereon caused by a low discharge number, which indicates that the nozzle 8 is used infrequently. The maintenance-needed nozzle determining unit 25 determines nozzle(s) 8 in need of maintenance according to the discharge numbers of each of the nozzles 8 calculated by the discharge number calculating unit 21. The nozzle(s) 8 in need of maintenance is determined by comparing the discharge number of the nozzles 8 with a preset reference value C1 (i.e., a first preset reference value). When the discharge number of the nozzle is a value less than or equal to the preset reference value C1 for a duration of the preset reference time, the nozzle 8 is in need of maintenance.

The maintenance-needed nozzle determining unit 25 determines the nozzle(s) 8 in need of maintenance by continuously accumulating the discharge number of each of the nozzles 8 until an amount of time that the corresponding cap 7 is open (i.e., a cap open time) reaches a preset reference time. As illustrated in FIG. 3, the nozzle(s) 8 in need of maintenance is determined if the discharge number of the nozzle 8 is less than or equal to the preset reference value C1, when the cap-open time finally reaches the preset reference time. Information about the nozzle(s) 8 in need of maintenance is stored in the memory 15, and the maintenance-needed nozzle determining unit 25 updates the information about the nozzle(s) 8 in need of maintenance until a spitting operation is performed thereon, and stores the information in the memory 15.

The cap-open time calculating unit 30 calculates accumulated cap open time for each nozzle 8 while the printing data is being printed. There are several ways in which to calculate the cap open time. The cap-open time calculating unit 30 may calculate the cap open time using resolution and a printing pace when printing the printing data, in a page unit. The cap-opening time calculating unit 30 may calculate the cap open time using file volume, resolution, and printing pace, in a file unit. Also, the cap-open time calculating unit 30 may calculate the cap open time by subtracting a printing starting time from a printing ending time, or may calculate the cap open time by counting printing time using a timer.

The wiper 40 wipes the discharge port to remove ink remaining therearound. The wiper 40 is disposed on an outer side of the nozzle 8 at one end of the print head 6. The wiper 40 may be shaped like a blade made of soft materials such as rubber and silicon.

The wiper driving unit 35 drives the wiper 40 to contact and move along the nozzle 8 in the lengthwise direction of the print head 6, under the control of the control unit 10.

The memory 15, which temporarily stores the printing data, also stores the discharge number for each of the nozzles 8 calculated by the discharge number calculating unit 21, the information about the nozzle(s) 8 in need of maintenance determined by the maintenance-needed nozzle determining unit 25, and the cap open time calculated by the cap-open time calculating unit 30. The information may be stored in the memory 15 until the maintenance is performed. For example, this information may be stored individually for each nozzle 8 until the maintenance operation is performed on the corresponding nozzle 8 or all the nozzles 8 together.

The control unit 10 performs maintenance of the printer by controlling the operation of the printing unit 5 and the maintenance unit 20. The control unit 10 may control maintenance operations that are scheduled at usual times (e.g., at pre-scheduled events or intervals), and the control unit 10 may control maintenance operations for the nozzles 8 as the need arises (i.e., adaptive maintenance operations).

The control unit 10 may control the maintenance unit 20 to perform maintenance operations in the following cases (1) when power is first supplied to the printer, (2) before printing is performed, and (3) when the discharge number of any nozzle 8 exceeds the preset reference value C2 (i.e., the second preset reference value C2). The maintenance operations may include the wiping operation and the spitting operation. The control unit 10 operates the wiper driving unit 35 and the nozzle heater 9 to perform the wiping and spitting operations, respectively.

The control unit 10 controls the maintenance unit 20 such that the nozzle(s) 8 in need of maintenance determined by the maintenance-needed nozzle determining unit 25 can perform the spitting operation, if the cap open time calculated by the cap-open time calculating unit 30 for the nozzle 8 reaches the preset reference time. That is, the control unit 10 operates the nozzle heater 9 of the nozzle(s) 8 in need of maintenance to perform the spitting operation, when the cap open time, which measures an amount of time that the discharge port of the nozzle 8 remains open, exceeds the preset reference time. The preset reference time may be set based on a time it takes ink in an area that is adjacent to the discharge port to harden due to the opened cap 7 (i.e., an ink-hardening time).

FIG. 4 is a flow chart illustrating a maintenance method using an array type inkjet printer according to an embodiment of the present general inventive concept. The method of FIG. 4 may be performed by the printer (i.e., including the printing unit 5 and the maintenance unit 20) of FIG. 2. Accordingly, for illustration purposes, the method of FIG. 4 is described below with reference to FIGS. 2 to 3.

If the power is supplied to the printer (operation S400), the control unit 10 operates the wiper driving unit 35 and the nozzle heater 9 to perform power on reset maintenance (PORM) which is a general maintenance operation (i.e., the wiping and spitting operations) (operation S405). If the printing data is received in this state (operation S410), the control unit 10 controls an image processor (not shown) to create a printing image (operation S415).

The control unit 10 operates the discharge number calculating unit 21 to extract information about positions and colors of each of the ink dots forming the printing image (operation S420). The discharge number calculating unit 21 calculates the discharge number of the nozzles 8 corresponding to the ink dots using the extracted information about the respective positions and colors of each of the ink dots (operation S425). Once the discharge number of each of the nozzles 8 are calculated, the maintenance-needed nozzle determining unit 25 extracts information about the nozzle(s) 8 in need of maintenance according to the calculated discharge number (operation S430).

Once the information about the nozzle(s) 8 in need of maintenance is extracted, the control unit 10 drives the wiper driving unit 35 and the nozzle heater 9 to perform (i.e., beginning of job maintenance) BOJM, which is another general maintenance operation that is performed prior to performing a printing job (operation S435). The control unit 10 then opens the caps 7 of each of the nozzles 8 (operation S440) and operates the cap-open time calculating unit 30 to begin measuring the cap open time (operation S445).

The control unit 10 determines whether the cap open time exceeds the preset reference time (operation S450). When the cap open time exceeds the preset reference time, the control unit 10 operates the nozzle heater 9 to perform the spitting operation (operation S455). The nozzle 8 in need of maintenance has the discharge number less than or equal to the first reference value (C1), when the cap open time reaches the preset reference time, for example, at N1 through N30 and at N72 through N100 in a graph of FIG. 3. When the nozzle(s) 8 in need of maintenance is finished with the spitting operation, the control unit 10 resets the cap open time stored in the memory 15, and restarts measuring the cap open time (the operation S440). Afterwards, the method, which may be controlled by the control unit 10, proceeds to operation S465. The cap open time can be a discharge number measurement cycle in which the number of times ink is ejected per cycle is monitored to determine performance of maintenance operations.

Unless the cap open time exceeds the preset reference time, or if the operations S455 and S460 are performed, the control unit 10 determines whether the discharge number of each of the nozzles 8 exceeds the second reference value (C2) (the operation S465). As a result, when any one of the nozzles 8 has a corresponding discharge number exceeding the second reference value (C2), for example, at N39 and N58 through N63 in the graph of FIG. 3, the control unit 10 performs the general maintenance operation. Accordingly, the control unit 20 operates the nozzle heater 9 of all the nozzles 8 to perform the spitting operation and controls the wiper driving unit 35 to drive the wiper 40 to perform the wiping operation (operation S470). Afterwards, the control unit 10 resets and restarts the cap open time and the discharge numbers of all the nozzles. The cap open time is reset, since the general maintenance operation targets all of the nozzles 8 in the print head 6, and accordingly the nozzle 8 in need of maintenance also performs the spitting operation.

The control unit 10 controls the printing unit 5 to print the image. The control unit 10 continuously determines, by a page unit and a file unit, whether the printing job is complete. Unless the printing job is complete, the method returns back to the operation S450 and repeats operation S450 through S485 until the image is printed and the printing job is complete. The operations S450 through S485 may be repeated as each page of the of the image is printing.

Likewise, the array type inkjet printer measures the cap open time and performs the spitting operation to the nozzles 8 in need of maintenance, the discharge number of which is less than or equal to the first reference value (C1) during a predetermined cap open time. In other words, the control unit 10 controls the nozzles 8 that discharge ink a number of times during the preset reference time that is less than the first reference value (C1) to perform the spitting operation. That is, the nozzles 8 selectively perform the spitting operation according to a number of printing ink ejections per unit time (i.e., a frequency of ink ejection). However, once a nozzle 8 in the print head 6 performs more than C2 printing ink ejections, the wiping and spitting operations are performed on all nozzles 8 in the print head 6. Accordingly, it is possible to prevent the ink from hardening in the less frequently used nozzles 8 in need of maintenance, and an ink wasting problem associated with a conventional method of performing the spitting operation on all the nozzles 8 does not occur in the present embodiment. In addition, efficient and proper maintenance are given according to a condition of each of the nozzles 8, so a lifespan of the print head 6 and the nozzles 8 may be maximized.

As described above, according to embodiments of the present general inventive concept, it is possible to prevent unnecessary ink consumption and enjoy an extended lifespan of a print head and nozzles 8.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An array type inkjet printer having an elongated print head and having a plurality of nozzles extending along a lengthwise direction of the print head, the array type inkjet printer comprising:
a discharge number calculating unit to calculate a number of times that each nozzle in the print head discharges ink based on an image to be printed;
a cap-open time calculating unit to calculate a cap-open time during which a discharge port of each nozzle is open by a corresponding cap; and
a control unit to control a maintenance operation to be performed on a nozzle when the cap open time reaches a predetermined reference time and when the number of discharging times of the nozzle is below a first predetermined reference value.

2. The array type inkjet printer of claim 1, wherein the discharge number calculating unit extracts at least one of information about a position of each ink dot in the image to be printed and information about a color of each ink dot that forms the image.

3. The array type inkjet printer of claim 2, wherein the discharge number calculating unit extracts the number of ink discharges of each nozzle corresponding to each ink dot from the at least one of the information about the position of each ink dot in the image to be printed and the information about the color of the ink dot that forms the image.

4. The array type inkjet printer of claim 3, further comprising:
a maintenance-needed nozzle determining unit to determine a nozzle in need of maintenance when the number of ink discharges of the nozzle is less than or equal to the first predetermined reference value for the predetermined reference time.

5. The array type inkjet printer of claim 4, wherein the maintenance operation comprises at least one of a spitting operation to spit the ink from the nozzles and a wiping operation to wipe the discharge ports of the nozzles with a wiper.

6. The array type inkjet printer of claim 5, wherein the control unit controls the print head such that the nozzle in need of maintenance performs the spitting operation when the cap-open time reaches the predetermined reference time.

7. The array type inkjet printer of claim 6, wherein the nozzles each comprise a nozzle heater to heat ink, and the control unit operates the nozzle heaters to perform the spitting operation.

8. The array type inkjet printer of claim 7, wherein the control unit resets the cap-open time and the information about the nozzle in need of maintenance, after the spitting operation is complete.

9. The array type inkjet printer of claim 8, wherein the control unit controls the print head and the wiper such that all the nozzles perform the spitting operation and the wiper performs the wiping operation on all the nozzles, when the number of ink discharges of at least of one nozzle exceeds a second predetermined reference value, and the control unit resets the cap open time and the information about the nozzle in need of maintenance after the spitting operation and the wiping operation are complete.

10. The array type inkjet printer of claim 1, wherein the predetermined reference time is set based on ink hardening time in the nozzles.

11. A printer, comprising:
a print head unit having a plurality nozzles;
a maintenance unit to monitor a frequency of ink ejection over a predetermined time cycle of each of the nozzles; and
a control unit to control the print head unit to print an image and to individually control a nozzle having a low frequency of ink ejection over the predetermined time cycle during the printing of the image to perform a spitting operation.

12. A printer, comprising:
a print head having a plurality of nozzles to print an image;
a maintenance unit to perform maintenance on the print head; and
a control unit to control the maintenance unit to perform one or more regularly scheduled maintenance processes on the print head and to control the maintenance unit to perform one or more non-regular adaptive maintenance processes on the print head based on the image printed.

13. The printer of claim 12, wherein the regularly scheduled maintenance processes comprise wiping and spitting when the printer is powered on and wiping and spitting before printing.

14. The printer of claim 12, wherein the adaptive maintenance processes comprise wiping and spitting selected nozzles according to corresponding frequencies of nozzle use.

15. The printer of claim 12, wherein the adaptive maintenance processes comprise determining which nozzles are used to print ink dots of the image, determining numbers of ink ejections for each nozzle, and spitting ink from nozzles that have less ink ejections than a predetermined value.

16. The printer of claim 12, wherein the adaptive maintenance processes comprise determining which nozzles are used to print ink dots of the image, determining numbers of ink ejections for each nozzle, and wiping and spitting all nozzles when at least one of the nozzles has more ink ejections than a predetermined value.

17. A maintenance method of an array type inkjet printer having an elongated print head and a plurality of nozzles arranged along a lengthwise direction of the print head, the method comprising:
calculating a number of times that each nozzle discharges ink based on an image to be printed;
calculating a cap-open time during which a discharge port of each nozzle is opened by a corresponding cap; and
performing a maintenance operation on a nozzle when the cap open time reaches a predetermined reference time and when the number of discharging times of the nozzle is below a first predetermined reference value.

18. The maintenance method of claim 17, wherein the calculating of the discharge number comprises extracting at least one of information about a position of ink dots in the image to be printed and information about a color of the ink dots forming the image to be printed.

19. The maintenance method of claim 18, wherein the calculating of the discharge number comprises calculating the number of ink dots discharged from each nozzle corresponding to each ink dot from the at least one of the information about the position of the ink dots in the image to be printed and the information about the color of the ink dots forming the image to be printed.

20. The maintenance method of claim 19, wherein the performing of the maintenance operation comprises determining a nozzle in need of maintenance when the number of ink discharges of the nozzle is less than or equal to the first predetermined reference value for the predetermined reference time.

21. The maintenance method of claim 20, wherein the performing of the maintenance operation further comprises at least one of a spitting operation to spit the ink from the nozzles and a wiping operation to wipe the discharge ports of the nozzles with a wiper.

22. The maintenance method of claim 21, wherein the performing of the maintenance operation comprises controlling the print head to perform the spitting operation on the nozzle when the cap-open time reaches the predetermined reference time.

23. The maintenance method of claim 22, further comprising:
resetting the cap-open time and information about the nozzle in need of maintenance, after the spitting operation is completed.

24. The maintenance method of claim 23, further comprising:
performing the spitting operation and the wiping operation on all the nozzles in the print head when the discharge number of at least one nozzle exceeds a second predetermined reference value; and
resetting the cap open time and the information about the nozzle in need of maintenance after the spitting and wiping operations are completed.
